(19) United States
(12) Patent Application Publication
(10) Pub. No.: US 2024/0020614 A1
(43) Pub. Date: Jan. 18, 2024

(54) Human Entanglement - A New Organizational Metric to predict business performance based on social network analysis

(71) Applicant: Peter A. Gloor, Cambridge, MA (US)

(72) Inventor: Peter A. Gloor, Cambridge, MA (US)

(21) Appl. No.: 17/812,606

(22) Filed: Jul. 14, 2022

(51) Int. Cl. G06Q 10/0639

(52) U.S. Cl. CPC G06Q 10/06393

(57) ABSTRACT

The present invention provides a system and procedure to introduce “entanglement”, a novel metric to measure how synchronized communication between team members is. This measure calculates the Euclidean distance among team members' social network metrics timeseries which is validated with four case studies. The first case study uses entanglement of 11 medical innovation teams to predict team performance and learning behavior. The second case looks at the e-mail communication of 113 senior executives, predicting employee turnover through lack of entanglement of an employee. The third case analyzes the individual employee performance of 81 managers. The fourth case study predicts performance of 13 customer-dedicated teams by comparing entanglement in the e-mail interactions with satisfaction of their customers measured through NPS. Entanglement is a new versatile indicator analyzing the hitherto underused temporal dimension of online social networks as a predictor of employee and team performance, employee turnover, and customer satisfaction.

### COPYRIGHT NOTICE

A portion of the disclosure of this patent document contains material which is subject to copyright protection. The copyright owner has no objection to the xeroxographic reproduction by anyone of the patent document or the patent disclosure in exactly the form it appears in the Patent and Trademark Office patent file or records, but otherwise reserves all copyright rights whatsoever.

### BACKGROUND

### Field of the Invention

The present invention relates generally to social network analysis mechanisms, and more particularly to methods and an apparatus for a new organizational metric to predict business performance based on social network analysis.

### Description of the Related Art

Albert Einstein called quantum entanglement “spooky action at a distance” (Einstein et al., 1935), predicting that quantum mechanics should allow objects to influence each other's action at great distance. It took other Nobel prize winning physicists' decades after Einstein's death to confirm his prediction. The current study proposes a similar social entanglement effect between people.

“You share everything with your bestie. Even brain waves.” (Angier, 2018). This is how the New York Times summarized the work of Parkinson et al. (2018), who found that brain scans of close friends show similar patterns as they watch a series of short videos. Using these results, the researchers trained a computer algorithm to predict the strength of a social bond between two people based on the relative similarity or synchronization of their neural response patterns. Such neural synchronization patterns are also observed in various other studies in different contexts, e.g., to determine neural contingencies between musical performers and their audiences. Hou et al. (2020) assess the neural synchronization between violinist and audience and the relation to popularity of violin performance. Their findings suggest that neural synchronization between the audience and the performer might serve as an underlying mechanism for the positive reception of musical performance. Further, neural synchronization can be confirmed by analyzing verbal group communication (Liu et al., 2019). Individuals try to achieve neural and body synchronization in order to facilitate fluid interaction (Fairhurst et al., 2013; Yun et al., 2012). Experiments show that synchrony of fingertip movement and neural activity between two persons increases after cooperative interaction (Yun et al., 2012).

Hence, engaging individuals in synchronized activities like walking, dancing etc. is an effective way of increasing subsequent cooperation between those individuals. However, the studies mentioned above focus on neural or body synchronization and are not applied in typical work environments or contexts. But “being in sync” or “in flow” in work environments is a relevant research topic and should be considered by decision-makers to determine the impact of such behavior on employee performance.

However, there exist opportunities to analyze online communication data in near-real time for continuous monitoring of team learning and performance. Metrics based on communication flow from person to person or amount of communication are suitable for real-time processing. In addition, studies have shown that analyzing online communication data in organizational contexts (de Oliveira et al., 2019; Gloor et al., 2017b) could be used as a predictor for job-related constructs, such as employee turnover or employee performance. Speed of responding to an e-mail, for example, is a good predictor of individual and team performance (Gloor et al., 2020). It might be a proxy for the passion of the person who is responding to an e-mail (Gloor, 2017), or for other external reasons such as urgency, power differentials, etc.

There are multiple inventions that have been disclosed to facilitate the Team synchronization and flow state but unfortunately, there is not a straightforward study and solution proposed in this domain.

The current invention proposes a sophisticated system where a structured methodology is introduced to answer these questions by introducing a metric called entanglement, which measures the synchronization of e-mail communication behaviors of team members and their flow state over time. This metric is grounded in SNA and identifies the similarity of timeseries of SNA metrics. The metric is validated by conducting four case studies, with different datasets from different organizations. Each case study is in a different context and variants of the entanglement measure are used as a predictor of different individual and group performance indicators

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary object of the invention is related to an advancement in a novel metric to measure how synchronized communication between team members is.

It is further the objective of the invention to provide a structured approach to calculate the Euclidean distance among team members' social network metrics timeseries.

It is also the objective of the invention to promote a new and versatile indicator for the analysis of employees' communication, analyzing the hitherto underused temporal dimension of online social networks which could be used as a powerful predictor of employee and team performance, employee turnover, and customer satisfaction.

It is also the objective of the invention to provide a novel synchronization metric, called entanglement, which is based on SNA of e-mail communication between different actors.

It is again the objective of the invention to provide an easy and simple metric entanglement which can also predict individual employee turnover and might help such studies to improve their prediction model quality.

It is also the objective of the invention to provide the Gini coefficient of betweenness entanglement, which is calculated from time series of betweenness centrality of each employee in the email network, demonstrating that it is associated with individual employee performance. A high Gini index of betweenness entanglement—indicating that an employee is strongly entangled with a small team, while being weakly entangled with the rest of the organization—significantly increases the chance of being a top performer.

This summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

non-limiting and non-exhaustive embodiments of the present invention are described with reference to the following drawings. The system and method of the present invention will now be described with reference to the accompanying flow chart drawing figure, in which:

FIG. 1 shows that Work-related flow leads to a better productivity and performance as per preferred embodiments of the invention.

FIG. 2 shows the communication activity of three persons by time as per preferred embodiments of the invention.

FIG. 3 illustrates the direction of an edge specifying the source (e-mail sender) and target (e-mail receiver) node; the weight of an edge shows the relation intensity (number of e-mails) between two nodes as per preferred embodiments of the invention.

FIG. 4 shows the e-mail communication activity of different people with the owner of the mailbox over a period of time, as per preferred embodiments of the invention.

FIG. 5 gives an intuitive motivation for the usefulness of group betweenness entanglement as per preferred embodiments of the invention.

FIG. 6 illustrates the Entanglement correlation with performance as per preferred embodiments of the invention.

FIG. 7 illustrates the Entanglement correlation with learning behavior as per preferred embodiments of the invention.

FIG. 8 illustrates the communication activity over time as per preferred embodiments of the invention.

FIG. 9 illustrates the SHAP values (prediction of leavers) as per preferred embodiments of the invention.

FIG. 10 illustrates SHAP values (prediction of top performers) as per preferred embodiments of the invention.

Table 1 shows the case studies overview as per preferred embodiments of the invention.

Table 2 shows the correlation for leavers as per preferred embodiments of the invention.

Table 3 shows the logistics regression for leavers as per preferred embodiments of the invention.

Table 4 shows the correlations for low performers as per preferred embodiments of the invention.

Table 5 shows the Logistic regression for low performers as per preferred embodiments of the invention.

Table 6 shows the Multilevel models for customer satisfaction (N=34, with 13 groups) as per preferred embodiments of the invention.

Table 7 shows the Case study results summary as per preferred embodiments of the invention.

Skilled artisans will appreciate that elements in the figures are illustrated for simplicity and clarity and have not necessarily been drawn to scale. For example, the dimensions of some of the features in the figures may be exaggerated relative to other elements to improve understanding of embodiments of the present invention. The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The current invention in its preferred embodiment aims to provide a sophisticated system based on the idea of using structured communication data to measure different categories of individual and organizational performance.

Synchronization is a fundamental element of life. Besides neuronal synchronization mentioned in the introduction, one finds studies that deal with the synchronization of human activities (Guastello and Peressini, 2017). Synchronization is often defined as the manifestation of unintended coordination. It is part of the natural behavior of a human being and takes place so invisibly that we usually do not notice it. It is triggered by audio-visual stimuli, haptic perception or simply by the presence of certain people. Synchronization can be analyzed as neuromuscular coordination, where there is a relatively exact or proportional tracking of body, hand and head movements, autonomic arousal, or electroencephalogram (EEG) readings between two or more people (Guastello and Peressini, 2017). For example, N'eda et al. (2000) show that the audience of a concert synchronizes its applause after an asynchronous start and Fairhurst et al. (2013) and Yun et al. (2012) show that people synchronize their finger tapping to improve coordination. While these studies only look at synchronization as neuromuscular coordination and task coordination, there are research efforts currently underway to uncover connections between synchronization in cognition, task structures, and performance outcomes in teams (Gipson et al., 2016). Better work performance outcomes would also be expected when teams are similarly synchronized (Elkins et al., 2009; Stevens et al., 2013). The hypothesis that team synchronization leads to better performance is further motivated by the theory of flow state. While the concept of synchronization in the above-mentioned studies applies a natural science perspective, human sciences like positive psychology consider synchronization as a part of flow state (Gloor et al., 2012) and expect flow state to cause better performance. A team is in flow state (Csikszentmihalyi, 1996) when members create a sense of shared confidence and empathy, which culminates in a collective mental state in which individual intentions harmonize and are in-sync with those members of the group. This condition is also referred to as achieving a “group mind”, which is marked by a deep emotional resonance which enables e.g., jazz musicians to be completely coordinated throughout the improvisational flow. In other words, group flow manifests itself in physical and verbal activities, for instance people mirroring each other and quickly finishing each other's sentences using the same words and phrases, indicating a “parallel synchronization of thought” (Armstrong, 2008). The more the team members are in-sync, the more likely it is to observe group flow.

Group flow can be analyzed applying “interaction analysis”, which entails closely observing and categorizing the interactions, movements, and body language of group members. But it cannot be limited to neurological studies of particular participants of the group's emotional conditions or subjective memories (Sawyer, 2003). Thus, group flow cannot be split down into specific tasks; rather, it is a process that arises from group dynamics and has the ability to improve job satisfaction, intrinsic motivation, vigor, performance or efficiency (Delarue et al., 2008; Sawyer, 2003; van den Hout et al., 2018). Hence, flow represents rather an oscillating dynamic state that combines continuous and sudden changes across time (Ceja and Navarro, 2012) than a static one.

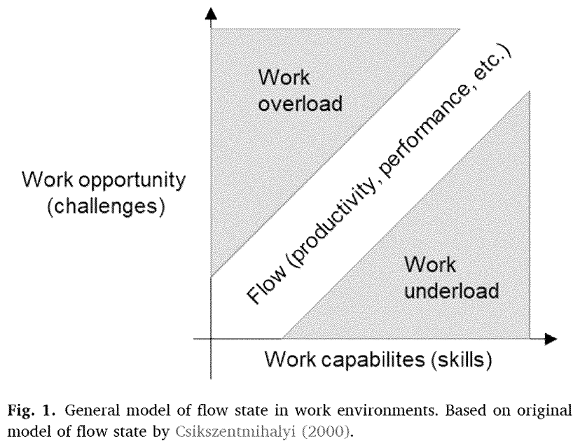

The flow concept can be transferred into the organizational context (Heyne et al., 2011). Bakker (2005) defines work-related flow as a short-term peak experience at work that is characterized by absorption, work enjoyment and interest. Teams “are in flow” if there is a certain balance between challenges and the skill sets of the individual team members. Work-related flow leads to a better productivity and performance (see FIG. 1). Further, by the definition of flow by Csikszentmihalyi (1996) high flow leads to high performance. If a team is collectively in flow, it therefore will deliver high performance. In general, flow is likely to correlate positively with measurable results (Quinn, 2005). Quinn (2005, p. 611) emphasizes that “[i]n knowledge work [ . . . ] flow may be a useful concept for understanding performance.”. Studies of flow proceed from a broader awareness that team processes like communication need to be studied as events over time (Arrow et al., 2004).

### Entanglement Conceptualization and Formalization

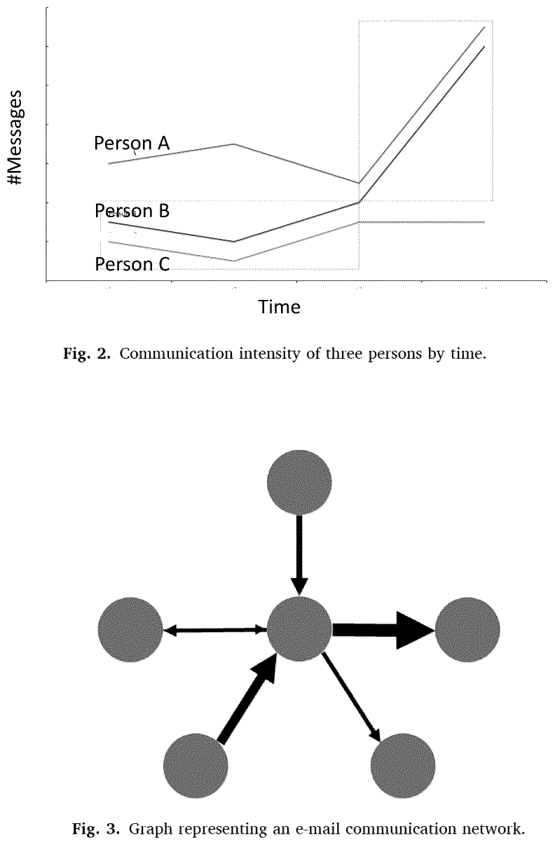

The idea of the entanglement measure is to determine how a person is in sync with his/her group and shares the same flow with the other team members, with regards to communication over a period of time. In an attempt to conceptualize entanglement, a multidisciplinary approach is proposed, bringing together concepts from several disciplines, ranging from quantum mechanics to human and social sciences. A result of this phenomenon is that when one measures the quantum state of one particle, one simultaneously determines the quantum state of the other particle. A quantum state (of a particle) is a representation of knowledge or information about an aspect of the system or reality (Pusey et al., 2012). In this study, we interpret the reality as the state about a person-to-person relationship. Thus, the two particles are seen as two individuals that have potentially interacted with “others”, not necessarily with each other, and have therefore become entangled. Our idea of synchronicity is that people are in-sync when they show similar behavioral patterns, such as communication activity. Hence, two persons are entangled even when they are physically separated or not involved in a (local) interaction with each other but share a similar communication behavior (an example is provided in FIG. 2).

Similar concepts have previously been described in psychology and sociology. “Entrainment” describes a process where one system's motion or oscillation frequency synchronizes with another system, for instance the brainwaves of two people rocking together in their chairs. Cross et al. (2019) defines interpersonal entrainment as the synchronization of organisms to a rhythm, for example singing, dancing, or even walking together. Much earlier, early twentieth century French sociologist Emile Durkheim defined collective effervescence as the similar but broader notion of synchronized action between humans (Durkheim, 2008), to describe when a community or society comes together to communicate the same thought or participate in the same action. This concept has been picked up by sociologist Randall Collins through his construct of “Interaction Ritual Chains” (Collins, 2005), which explain collective action through shared emotional energy. The common theme of all these constructs is colocation, people creating and experiencing emotional energy by being together at the same location. We therefore prefer the term “entanglement” to describe synchronous action between humans independent from where they are located, to describe in the words of Albert Einstein, “spooky action at a distance”.

Human communication is fundamentally synchronous and rhythmic, two important characteristics of individual and interactional behavior (Condon, 1986). The synchronization of interactional behaviors helps to generate a sense of flow state for the persons involved (Condon, 1986). Further, it always takes other people for a person to reach the state of flow (Collins, 2005), while the other people do not have to be physically present. Thus, entanglement leads to a flow state of two persons analogous to the “mysterious change” of a particle's quantum state. Intuitively, we propose that the “more similar the communication” of two persons A and B is, the more person A is in sync and is able to share the same flow of communication with person B over a period of time. Individuals that are in flow might have higher abilities to productively channel their cooperative spirit when working together.

FIG. 2 shows the communication of three persons by time. Person B and C communicate in similar intensity (here: number of sent messages) from t1 until t3. Their communication decreases from t1 to t2 and increases from t2 to t3 by the same amount. Further, their lines in the chart are very close together meaning the distance between each of their data points is short. We observe the same pattern for person A and person B in time period t3 and t4. Such patterns might indicate synchronization.

Thus, we can state that the distance of the data points representing the communication intensity between two or more persons in a specific time window is an indicator for their synchronization. Here, we use the Euclidean distance, a straight-line distance between two points in Euclidean space. We calculate the Euclidean distance d of two data points x and y of a communication metric A of the same time window t with:

d(A(xₜ),A(yₜ))={square root over ((A(xₜ)−A(yₜ))²)}

This Euclidean distance specified in the formula above is calculated for every pair of nodes and time window t. An essential requirement to determine if persons are entangled is to consider both team synchronization and team flow. Team flow is based on flow experienced in relational embeddedness (Burt, 2005) which can be established by e.g., communication and collaboration. To address this structural feature of communication, we propose to apply SNA. SNA offers a suitable methodology to study group dynamics as well as to investigate the role of the individuals within these dynamics (Wasserman and Faust, 1994). It focuses on various aspects of the relational structures and the flow of information, which characterize a network of people, through graphs and structural measures.

To better illustrate the concept of “entanglement” we consider an email network, characterized as a graph made of a set of nodes (e-mail accounts) and a set of directed edges (weighted by the number of emails) connecting these nodes. The direction of an edge specifies the source (e-mail sender) and target (e-mail receiver) node; the weight of an edge shows the relation intensity (number of e-mails) between two nodes (see FIG. 3). For example, if person A sends 3 emails to person B, we see an arc originating at node A and terminating at node B of weight equal to 3.

To illustrate the idea and calculation of entanglement with an example, we use an individual mailbox representing a dataset of e-mails of persons that work together on several projects. First, we collected the mailbox and stored it in a database, where the e-mail data was structured from a network perspective. In order to calculate the entanglement of the mailbox owner and his/her colleagues, we take the inverse of the Euclidean distance of the time series of the communication activity represented by messages sent over time for each node/actor in the network. This value will get the larger the more similar the activity time series of two actors are. However, we have to distinguish between two pairs of actors at different locations in the network, one pair embedded into a tight cluster communicating with many other actors, while the other pair is exchanging the same number of e-mails as the first pair, but is only weakly connected to other actors. To make this metric comparable among pairs of actors with different levels of activity in the same network, we multiply it by the product of the degree centralities of both actors. Degree measures the centrality, sometimes seen as a proxy of popularity, of a node in a network, by counting the number of its nearest neighbors (Freeman, 1978).

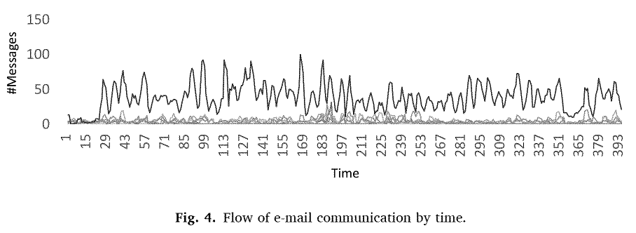

Further it can be a proxy for the level of engagement within a group, team or organization (Gloor et al., 2020). Communication activity via e-mail (Gloor et al., 2014) indicates the number of e-mail messages sent by a person within a time interval. FIG. 4 shows the e-mail communication activity over a period of time, for the email box we analyzed. The blue line shows the mailbox owner's communication activity, the other lines correspond to the people s/he is exchanging e-mails most frequently with. The more correlated the communication activity between the owner of the mailbox and another person are, the more they are in sync, share the same flow over a period of time, and thus are entangled. The picture also illustrates the need to include degree centrality in the entanglement formula, as the levels of activities, while running in parallel, are vastly different for different people.

Accordingly, we define the activity entanglement EA (xT, yT) between two individuals, named x and y in a specific time window T, as:

$${E}_{A} ( {x}_{T} , {y}_{T} ) = \frac{{C}_{D} ( {x}_{T} ) {C}_{D} ( {y}_{T} )}{d ( A ( {x}_{T} ) , A ( {y}_{T} ) )}$$

where CD (xT) and CD (yT) are the degree centralities of the two individuals x and y, and d(A(xT), A(yT)) is their Euclidean distance, with respect to communication activity A in a defined time window T. In other words, the entanglement of two individuals x and y is given by the multiplication of the number of their direct contacts in the e-mail network divided by their synchronization of communication activity. As has been said above, it is necessary to include the product of the degree centralities of x and y into the entanglement formula to provide for the differences in centralities between actors: assume that actor x has low degree, if x is synchronized with highly connected actor y having high degree centrality, the high degree of actor y will boost entanglement of actor x in comparison with all other actors in the network. In other words, we want our metric to reward less influential actors that are synchronized with influential actors.

Similarly, we could consider not just communication activity, but also individuals' synchronization in weighted and unweighted betweenness centrality. Betweenness is a well-known metric in social network analysis. It is the sum of the fraction of all-pairs shortest paths that pass through a node v (Freeman, 1977):

$${C}_{B} ( v ) = {\sum }_{s \neq v \neq t ∈ V} \frac{σ ( s , t \vert v )}{σ ( s , t )} ,$$

where V is the set of nodes, σ (s, t) is the number of shortest paths from s to t, and σ (s, t|v) is the number of those paths passing through node v (Brandes, 2001). Inverse arc weights are considered for the determination of node distances. To control for network size, the above index is usually normalized between zero and one.

If the betweenness centrality time series of two individuals are in sync, it means that they share similar network positions, and levels of influence, at the same time. Individual betweenness entanglement EB is the product of the degree of two individuals divided by their Euclidean distance in betweenness centrality over a period of time.

$${E}_{B} ( {x}_{T} , {y}_{T} ) = \frac{{C}_{D} ( {x}_{T} ) {C}_{D} ( {y}_{T} )}{d ( {C}_{B} ( {x}_{T} ) , {C}_{B} ( {y}_{T} ) )}$$

In addition, we speculate on the possibility to evaluate how much an individual is in sync with the aggregated flow of the entire network. As a proxy of the aggregated rhythm of the team we take Freeman's group betweenness centralization, CGB (Freeman, 1978). Group betweenness centralization is the sum of the differences between the betweenness centrality of the most central node, CB(v*), and that of all other nodes in the network (Freeman, 1978; Wasserman and Faust, 1994), normalized by its maximum value which is (G−1)²(G−2) where G is the total number of nodes:

$${C}_{GB} = \frac{2 {\sum }_{i = 1}^{G} [ {C}_{B} ( {v}^{*} ) - {C}_{B} ( {v}_{i} ) . ]}{{( G - 1 )}^{2} ( G - 2 )} .$$

This definition of group betweenness centralization is appropriate for this use case, as we compare how entangled an individual node is with all other nodes with regards to betweenness.

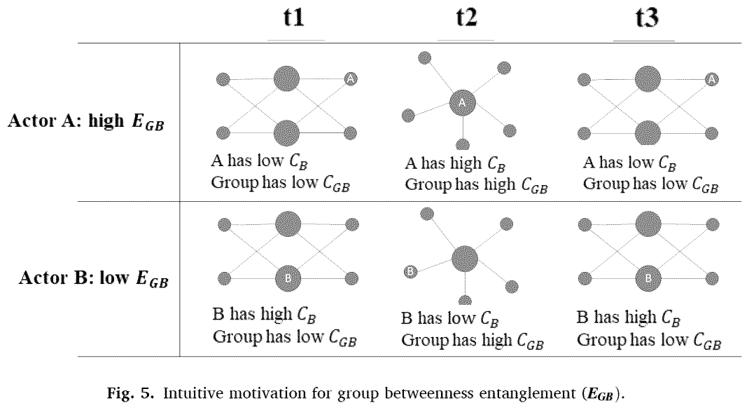

FIG. 5 gives an intuitive motivation for the usefulness of group betweenness entanglement. It shows a group of six actors at three points in time of a changing network structure. Actor A is very much “entangled” with the overall group: In t1 and t3, when the group betweenness centralization (CGB) is low, his/her (individual) betweenness centrality (CB) is low also, in t2, when the group betweenness centralization is high, his/her CB is high too, leading to low Euclidean distance of his/her CB to CGB, resulting in high entanglement. In contrast, actor B is lowly “entangled” with the group, in t1 and t3 when CGB is low, his/her betweenness centrality (CB) is high, in t2 when CGB is high, his CB is low. This leads to high Euclidean distance to CGB, and thus to low entanglement.

Formally, we measure group betweenness entanglement EGB by dividing group betweenness centralization CGB by the Euclidean distance of group betweenness centralization and normalized betweenness centrality of the actor being analyzed over a time period. CGBT—as a metric of variation—is an indicator for the centralization of the group in time window T, the individual betweenness centrality CB (xT) in this sense is an influence on CGBT, i.e., how much an actor impacts CGBT. Intuitively, this metric reflects the contribution of this actor to the level of centralization of its group. In other words, it measures how far away the normalized betweenness centrality of an actor is from the betweenness centralization of its group at any point in time. If an actor's betweenness is high and its group betweenness centralization is high, the actor is probably responsible for the centralized network structure—thus the Euclidean distance between group betweenness centralization and an actor's betweenness centrality is small, and therefore the actor's group betweenness entanglement high. On the other hand, if an actor's betweenness is low and its group betweenness centralization is high, it means somebody else is central and the actor is unimportant in betweenness centrality terms, thus less entangled with the group.
betweenness entanglement, E_{GB}(x_{T}) of x as:

$${E}_{G B} ( {x}_{T} ) = \frac{{C}_{{GB}_{T}}}{d ( {C}_{B} ( {x}_{T} ) , {C}_{{GB}_{T}} )}$$

To show the inequality in individual group betweenness entanglement we calculate the Gini coefficient for EGB:

$$G ( {E}_{GB} ) = \frac{{\sum }_{i = 1}^{n} {\sum }_{j = 1}^{n} \vert {E}_{GB} ( {x}_{i} ) - {E}_{GB} ( {x}_{j} ) \vert}{2 {n}^{2} \overline{{E}_{GB}}}$$

The same formula can also be used for activity entanglement to calculate G(E_{A}). Intuitively, the Gini coefficient measures inequality in the distribution of entanglement among all actors in a network. This is based on the observation that for an actor x being resource-poor or resource-rich in a network—the resource being entanglement in this case—can be highly predictive for the behavior or performance of x. It therefore makes sense to put the entanglement of x in relationship to the entanglement of all other actors in the network through Gini entanglement.

This is illustrated by four case studies that show how the proposed entanglement metric can be used with e-mail data to predict work-related outcome variables, such as team performance and employee turnover. The four cases are related to different business contexts and consider different dependent variables. In all cases we analyze email data, illustrating the suitability of the entanglement metric for online communication data. Our goal here is not to directly compare results across case studies, deriving general conclusions, or claiming causality. Rather we want to show the versatility of our entanglement metrics, which can be adapted to study business interaction dynamics in different scenarios.

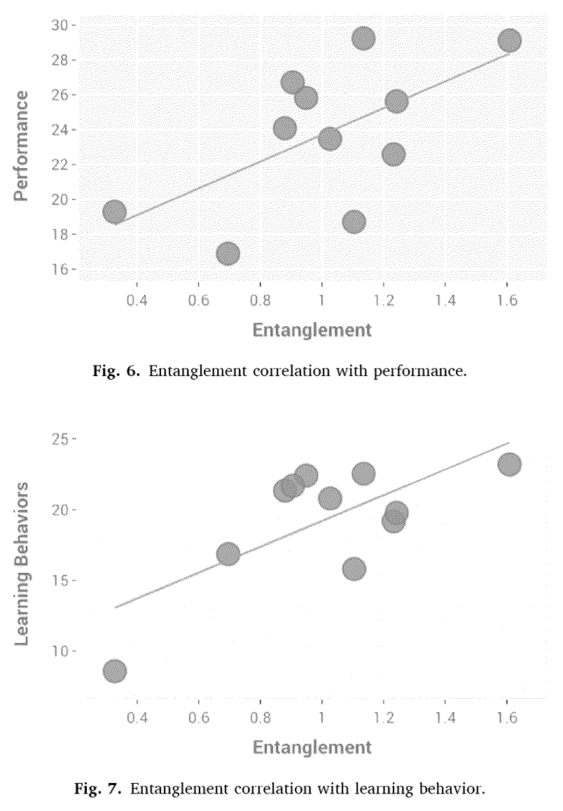

Case study A—learning behavior and performance: This case study was conducted as a pilot in a health care organization to determine if activity entanglement E_{A} between 53 team members of 11 medical innovation teams could predict performance and learning behaviors. The performance and learning behaviors of each team was rated and triangulated every other month for the duration of a year by three overall project managers. They individually rated the team performance and the capability of a team to learn new things. At the same time, all e-mails of the project members were collected and analyzed. Individual activity entanglement of each actor with all other actors was calculated, and then the average was taken for each actor. Finally, for each team average and standard deviation of activity entanglement over all team members was computed. We find that team performance and learning behavior are significantly correlated with the standard deviation of activity entanglement of team members, as shown in FIG. 6 and FIG. 7 (which show a scatter plot of the two metrics, with a fitted regression line). The Pearson's correlation coefficient of the standard deviation of activity entanglement of team members with team performance is 0.615 (p=0.045) and with learning behavior is 0.707 (p=0.015). In other words, the wider the spread in activity entanglement E_{A} of the team members, the higher their performance and learning behavior. This pattern corresponds to a few core team members being strongly entangled, and the remaining members showing weak E_{A}. We also notice that moderate dispersion of entanglement is associated to higher variability in performance scores. This could be explained by control variables we could not collect in this study due to limited data availability. Alternatively, it could suggest that in order for performance to be high, few employees have to take a strong group lead, guiding the others towards a common goal.

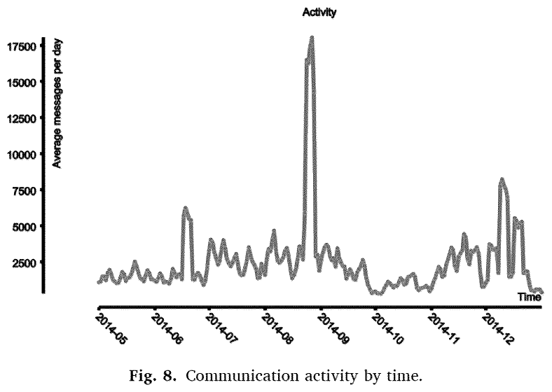

Case study B—turnover prediction: In our second case study, we conducted a pilot study at a global professional services firm. In this case we wanted to evaluate the possible association of entanglement with executives' decision to leave the firm, through voluntary resignation. Turnover of highly important employees such as senior executives is critical for companies, because it has negative implications for firm performance (Hancock et al., 2013; Zylka and Fischbach, 2017). Eight months of e-mail data of 113 senior executives at a large global services company was collected from May to December 2014 (see FIG. 8). We calculated activity entanglement E_{A} of 55 employees who left the firm from January to May 2015. To determine the inequality in entanglement, we also calculate the Gini index of E_{A}, for each person (from an ego perspective) in the network, considering her/his entanglement and that of all other peers. The Gini index measures the dispersion of entanglement scores of a social actor with all others in the network. In an “egalitarian” network with low Gini index for each node, all actors are either highly or weakly entangled, in a “non-egalitarian” network with high Gini index some actors are highly entangled, while others are weakly entangled. This was compared with the activity entanglement E_{A} of a control group made of 58 employees, who were selected randomly and still working in an unterminated position at the firm in June 2015.

From a preliminary t-test, we immediately notice that there is a significant difference in the Gini index of activity entanglement, between senior executives who leave the company (M=0.457, SD=0.070) and those who stay (M=0.488, SD=0.059), t(111)=−2.513, p=0.013. On average, Gini entanglement is significantly higher for those who stay.

Past studies have shown that managerial disengagement might depend on multiple factors and that communication-based and social network analysis metrics, captured from e-mail communication, can reveal it (Gloor et al., 2017b). Accordingly, we present Pearson's correlations (in Table 2) and logistic regression models (in Table 3), to see if the effect of the entanglement variable remained significant when combined with other predictors. The highest correlation of entanglement is with contribution index, which however does not lead to collinearity issues. A high contribution index is an indication for “spammers”, the higher the contribution index, the more somebody sends compared to receiving e-mail. If there is a spammer, s/he will be entangled with many, while others who are sending much less, will thus be less entangled. This results in a high Gini entanglement for that person. Extending this effect to all users will lead to high correlation between the two values.

We first tested a model with only the control variables of rank, tenure, and time since last promotion (TSLP) measured in months. In the subsequent models, we added the other predictors in blocks showing, in Model 4, that the only significant predictor, before adding entanglement, is Ego ART. This suggests that managers who leave the company are less responsive to e-mails and take more time to answer. In the full model, Ego ART, messages sent, contribution index and Gini activity entanglement are significant. Including this last predictor in the model leads to a significant improvement of the McFadden's pseudo-R-squared, which more than doubles (going from 0.08 to 0.18). As we can see from Model 5, a higher Gini entanglement makes the probability of leaving the company smaller.

To evaluate the possibility of using the entanglement variable for making predictions, we used machine learning. In particular, we used a tree boosting model named CatBoost and its related Python library (Prokhorenkova et al., 2018). This boosting approach is now well-known and proved its usefulness in past research, where it also sometimes outperformed other supervised machine learning methods, such as Support Vector Machines (SVM) and Random Forest Models (Huang et al., 2019). The model performance has been assessed through Monte Carlo Cross Validation (Dubitzky et al., 2007), with 300 random splits of the dataset into train and test data (75% vs 25%). Thanks to the contribution of our variables, we could achieve an average accuracy of predictions of 80.25%, with an average value of the Area Under the ROC-Curve (AUC) of 0.81.

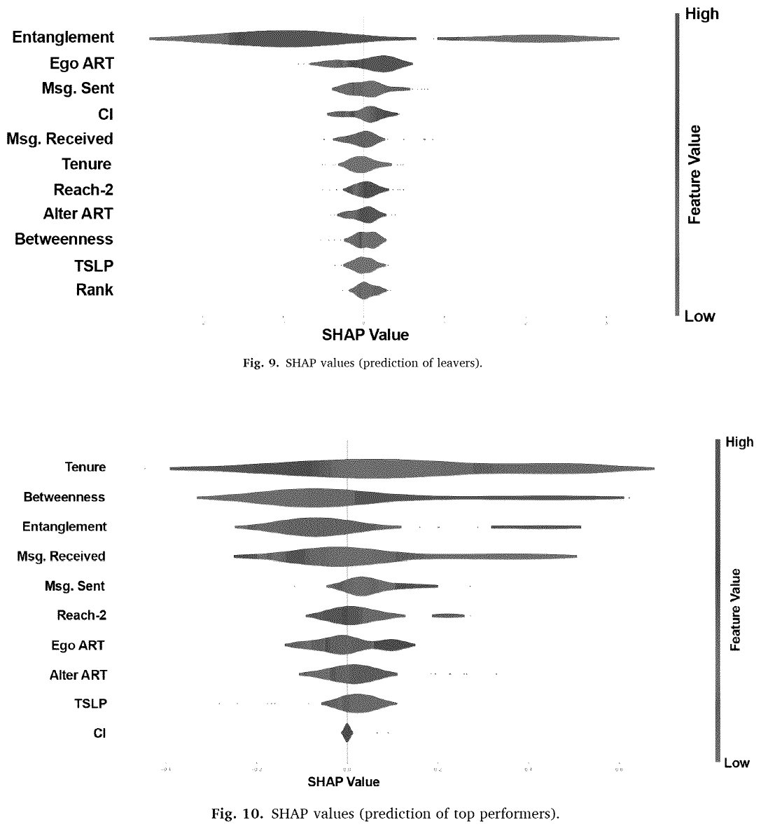

In a second step, we considered the average model resulting from cross-validation and used it to interpret the impact of each variable on predictions (calculated as the average of its absolute Shapley values). We used the SHapley Additive exPlanations (SHAP) Python package (Lundberg and Lee, 2017). This method proved to be particularly suitable for tree ensembles and to work well also with respect to other approaches (Lundberg et al., 2020, 2018). As FIG. 9 shows, the Gini index of activity entanglement is the variable with the highest impact on model predictions. Its contribution is much higher than all other variables, again supporting the importance of this metric. At the second place, we find Ego ART. Results are consistent with those of logit models and indicate that managers who are slower in answering e-mails, and have low Gini entanglement, are more likely to leave the company. Low Gini entanglement means that they show constant levels of entanglement, either being entangled with almost nobody or everyone—a situation that might be stressful to maintain, especially when associated with email overload (Reinke and Chamorro-Premuzic, 2014). Average/high levels of Gini entanglement, on the other hand, have a positive impact on the prediction of staying in the company. This means that these managers show uneven entanglement, being highly entangled with some colleagues while being weakly entangled with others.

Case study C—employee performance: We analyzed the e-mail interactions of 81 managers working for a big international services company. Every year the performance of managers was evaluated by their bosses and by the HR department. Whereas the rating of almost all of these managers was “exceeded expectations” for the year 2015, we noticed that 15 of them obtained a lower rating. Like in the case study B of resigning senior executives, we were interested in understanding if entanglement could be related to individual work performance. Carrying out a t-test, we could see that there is a significant difference between the Gini coefficients of betweenness entanglement EB scores of tops (M=0.508, SD=0.061) and low (M=0.469, SD=0.028) performers, t(79)=2.432, p=0.017.

As we did for leavers in case study B, we additionally built logistic regression models to assess the combined impact of variables on the probability to be a low performer. Pearson's correlations among our predictors are presented in Table 4. The highest correlation of entanglement is again with contribution index, but this time lower than case study B.

As Table 5 shows, in the full model the p-value of Gini entanglement is only <0.1; however, the inclusion of this variable leads to a good improvement of the McFadden's pseudo-R-squared, from 0.2314 (Model 4) to 0.2803 (Model 5). A significant performance improvement is also obtained by including weighted betweenness centrality.

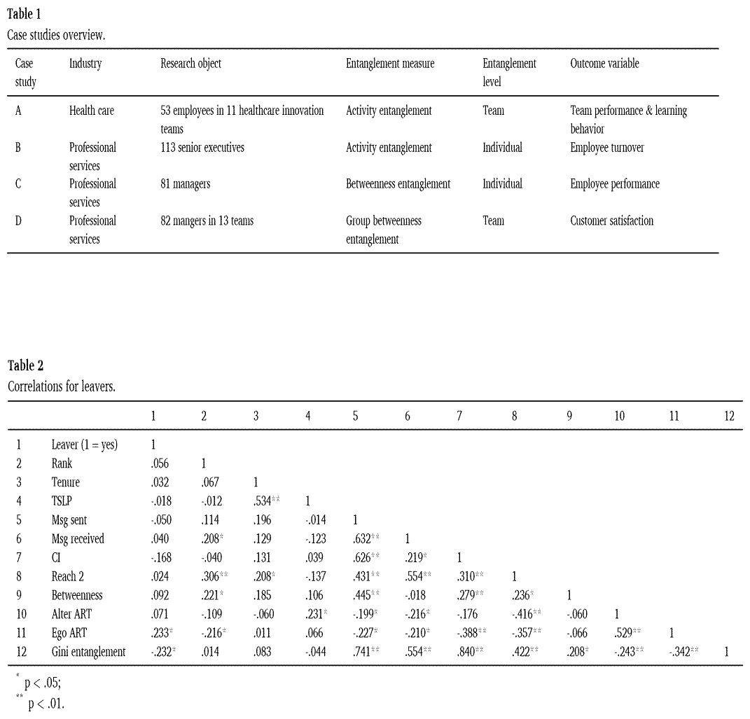

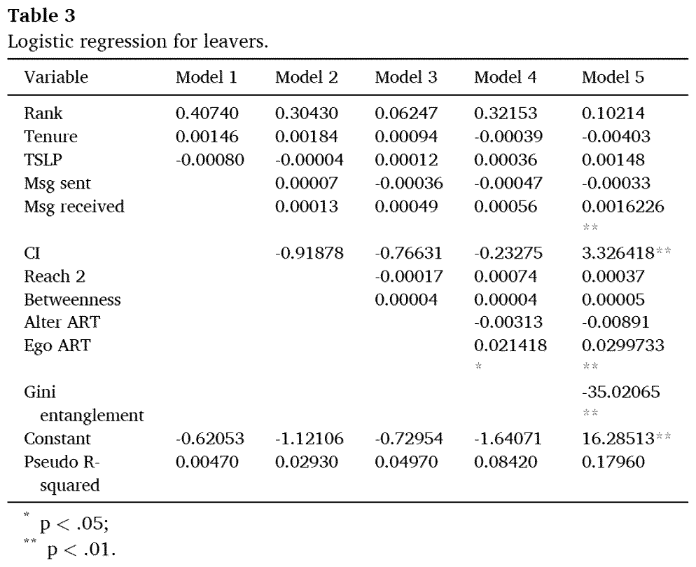

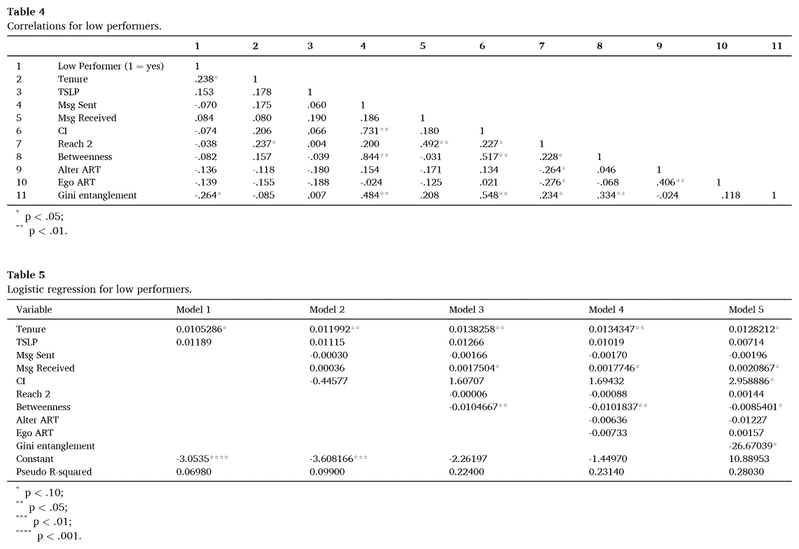

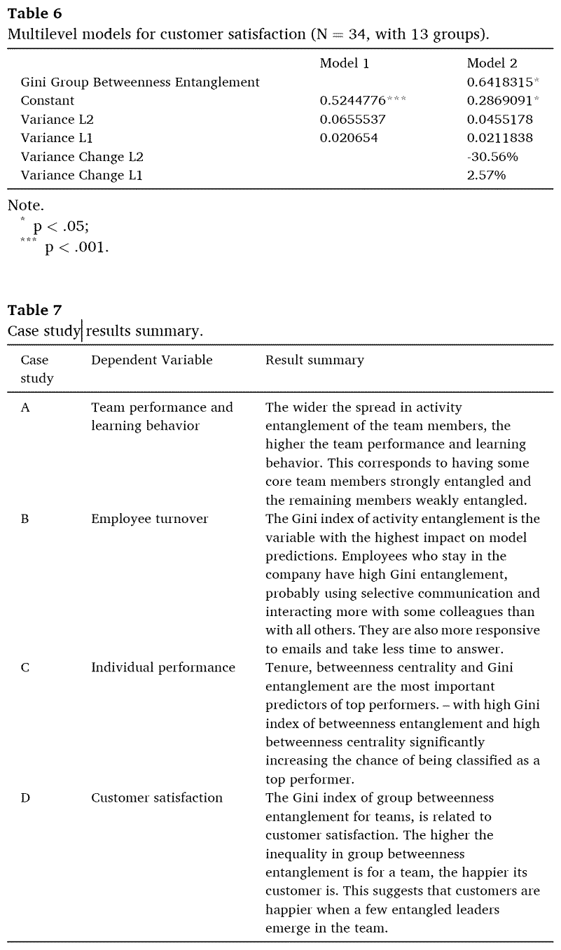

The usefulness of the entanglement predictor is confirmed by the results of the CatBoost model that we trained to classify managers into top and low performers. We followed the same procedure as in the previous case study B—i.e., a Monte Carlo cross-validation with 300 repetitions—and obtained good average results (Accuracy=74.73%, AUC=0.68). FIG. 10 shows the Shapley values associated with each predictor. For an easier reading, we coded top performers as 1 and low performers as 0 (here the model is predicting top performers, which is exactly symmetrical to the choice of predicting low performers that we did in Table 5). Tenure, betweenness centrality and entanglement are the most important predictors—with high Gini coefficient of betweenness entanglement and high betweenness centrality significantly increasing the chance of being classified as a top performer.

These managers are highly entangled with some colleagues, and weakly entangled with others—demonstrating selective communication behavior with close collaborators, while being efficient with their time and communicating comparatively less with the rest of the organization. Regarding tenure, we observe the opposite effect, with recently hired employees generally receiving better ratings.

Case study D—Customer Satisfaction: In this case study, we show that entanglement is significantly related to team performance, measured as customer satisfaction through the Net Promoter Score (NPS). 13 teams within the company participated to our study, comprising a total of 82 managers. Each team was dedicated to a specific client.

We measured betweenness entanglement of each team by taking the group betweenness entanglement of each member and considering group dispersion by means of the Gini coefficient.

We find that high group betweenness entanglement inequality is positively related to team performance—this time measured as customer satisfaction. Running a Pearson's correlation test, we find a significant association of Gini group betweenness entanglement with team performance (r=0.522, p=0.002). For each team we have repeated measures over three time periods. Therefore, we used multilevel linear models (Hoffman and Rovine, 2007; Nezlek, 2008; Singer and Willett, 2009) as a more appropriate technique to evaluate the possible effect of entanglement on customer satisfaction. We nested repeated measures into groups (level 2). Results are presented in Table 6.

As the table shows, the biggest variance proportion can be attributed to team characteristics: the intraclass correlation coefficient is 0.7604, meaning that 76% of the empty model variance is at level 2 (Model 1). Including the entanglement variable in the model (Model 2) reduces this variance of 30.56%, which is a highly significant result for a single predictor. The higher the inequality in group betweenness entanglement is, the happier the customer is. Similarly, to case study A, this confirms that selective communication of teams, where some team members are highly entangled and others are not, leads to happier customers.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1: The current invention aims to provide an efficient synchronization metric, called entanglement, which is based on SNA of e-mail communication between different actors.

2: The dispersion of activity entanglement is positively associated with team performance wherein:
As per claim 2, the synchronized communication activity of some team members and their continuous similar flow state improve the performance of the team;
As per claim 2, the e-mail communication and face-to-face communication frequency and flow in knowledge work, can both lead to higher team performance;
As per claim 2, the best teams exhibit higher dispersion, comprising highly entangled team members and more peripheral ones;
As per claim 2, the teams might benefit from strong leadership of few selected individuals that can guide and inspire others;
As per claim 2, the proposed metric entanglement can also predict individual employee turnover and might help such studies to improve their model quality.

3: The Gini coefficient of betweenness entanglement, as well as betweenness centrality, are associated with individual employee performance wherein:
As per claim 3, a high Gini index of betweenness entanglement significantly increases the chance of being a top performer;
As per claim 3, the focused communication which includes communicating intensively and highly synchronized with a few select colleagues, while reducing communication with the rest of the organization is an indicator of high performance;
As per claim 3, the inequality of group betweenness entanglement in teams positively influences customer satisfaction wherein:
As per claim 3, the stronger leaders with high entanglement emerge in groups, the happier the customer is;
As per claim 3, a strongly entangled leaders who influences team dynamics over time, while the rest of the team is rather passive, will lead to satisfied customers; and,
As per claim 3, a positive relationship between centralized leadership and teams' performance, suggests that distributed leadership structures can differ with regard to important structural characteristics, and these differences can have positive or negative effects.
